(19) United States
(12) Patent Application Publication
(10) Pub. No.: US 2018/0250919 A1
(43) Pub. Date: Sep. 6, 2018

(54) METHOD FOR ROLLING UP A WEDGE-SHAPED FILM

(71) Applicant: SAINT-GOBAIN GLASS FRANCE, Courbevoie (FR)

(72) Inventors: Stephan GIER, BOUS (DE); Stefan LUECKE, ALSDORF (DE)

(21) Appl. No.: 15/740,798

(22) PCT Filed: Dec. 9, 2016
(86) PCT No.: PCT/EP2016/080359

§ 371 Date: May 11, 2018

(30) Foreign Application Priority Data
Dec. 14, 2015 (EP) 15199812.7

(51) Int. Cl. B32B 17/10; G02B 27/01

(52) U.S. Cl. CPC B32B 17/10568; B32B 17/10761; B29C 47/0035; G02B 27/01; B32B 17/10036

(57) ABSTRACT

A method for rolling up a wedge-shaped film is described. In the disclosed method, a wedge-shaped film and a wedge-shaped intermediate layer are wound together onto a winding core. According to one aspect, the thicker edge of the wedge-shaped intermediate layer is positioned at least flush on the thinner edge of the wedge-shaped film. According to another aspect, the thinner edge of the wedge-shaped film is from 0.7 mm to 0.9 mm and the thicker edge is from 1.1 mm to 1.3 mm, and the thinner edge of the wedge-shaped intermediate layer is from 0.01 mm to 0.05 mm and the thicker edge is from 0.4 mm to 0.55 mm.

The invention relates to a method for rolling up a wedge-shaped film, the rolled-up wedge-shaped film, and the use thereof.

“Wedge-shaped film” means a thermoplastic film for a composite glass pane with a wedge insert in the vertical direction. Composite glass panes are currently used in many places, in particular in the vehicle sector. The term “vehicle” is construed broadly and relates among other things, to road vehicles, aircraft, watercraft, agricultural machinery, or even work equipment. Composite glass panes are also used in other areas. These include, for example, architectural glazing as well as information displays, e.g., in museums or as promotional displays.

A composite glass pane has, in general, two glass panels that are laminated by means of an intermediate layer. The glass panels themselves can be curved and usually have a constant thickness. The intermediate layer usually has a thermoplastic material, such as polyvinyl butyral (PVB).

Since the composite glass is generally inclined relative to an observer, double images occur. These double images are caused by the fact that incident light usually does not completely pass through both glass panels, but that, instead, part of the light is first reflected and only passes through the second glass panel after that. These double images are perceptible, in particular, in darkness, in particular with strongly radiating light sources, such as the headlights of an oncoming vehicle. These double images are extremely bothersome.

Frequently, the composite glass pane is also used as a head-up display (HUD) for displaying information. Here, an image is projected onto the composite glass pane by means of a projection device in order to display data to the observer in the field of vision. In the vehicle sector, the projection device is arranged, for example, on the dashboard and the projected image is reflected in the direction of the observer on the nearest glass panel of the composite glass pane inclined toward the observer.

However, again, part of the light enters the composite glass pane and is then reflected on the inner boundary layer of the glass panel that is farther out from the observers perspective and the intermediate layer and then exits the composite glass pane at an offset. Here, as well, a similar effect occurs relative to the image to be displayed, the ghost image effect. The result is that the respective observer becomes irritated or, in the worst case, receives incorrect information.

To date, the attempt has been made to solve this problem by no longer arranging the surfaces of the glass panels parallel but, instead, at a fixed angle relative to one another. This is accomplished, for example, in that the intermediate layer has a linearly increasing and/or decreasing thickness. In the vehicle sector, the thickness is typically varied such that the smallest thickness is provided at the lower edge of the pane toward the engine compartment, while the thickness increases linearly toward the roof. The intermediate layer has the shape of a wedge.

It has, however, been shown that the previous wedge angle progressions can only inadequately minimize ghost images of head-up displays. The wedge angle is the angle measured at a point between the surfaces of the insert. The wedge insert is continuous with respect to thickness. The wedge insert or thermoplastic film has a continuous change in thickness. A linearly continuous change would correspond to a conventional constant wedge angle. A continuous change results from a nonconstant wedge angle profile, wherein the wedge angle is location-dependent. The wedge angle profile can be linear or nonlinear.

The thermoplastic film has a continuous wedge angle profile, at least in sections, in the vertical direction, with the wedge angle profile having a first section that has, for avoiding ghost images in transmission, a wedge angle that is constant or variable, at least in sections, and with the wedge angle profile further having a second section that connects with the first section, which second section has, for avoiding ghost images in reflection, a variable wedge angle, wherein the wedge angle from a lower end to an upper end is a function of the distance from the lower end or from the upper end, wherein the function is at least a second grade function, wherein the second section substantially minimizes ghost images of a head-up display, with the wedge angle profile further having a third section that connects to the second section, which third section has, for avoiding ghost images in transmission, a wedge angle that is constant or variable, at least in sections, wherein a wedge angle in the third section is substantially equal to or larger than the wedge angle at the lower end of the first section.

From WO 2015086234 A1, a thermoplastic film for a composite glass pane with a nonlinear-continuous wedge insert in the vertical direction is known, wherein the composite glass pane is, in the vertical direction, from the viewpoint of an observer, farther away from the observer in the vertical direction at a lower end than at an upper end, wherein, in a composite glass pane outfitted therewith, the thermoplastic film is situated between two glass layers.

For transport and for storage, wedge-shaped films are wound onto a core. Here, the wedge-shaped film is wound tightly on the side of the thicker edge and wound loosely on the side of the thinner edge. This results in creases on the side of the thinner edge. The creases increase with the length of storage of the wedge-shaped film on the roll. After the cutting of the wedge-shaped film into sheets, the sheets are wavy and have creases. The transport and storage temperature of the wedge-shaped film must be kept at 2° C. to 10° C. to prevent adhesion of the film. The cooling of the film increases its stiffness. The increased stiffness renders the removal of creases that were formed more difficult. The wedge-shaped film can be stored only briefly on the roll in order not to increase the formation of creases. The rolls must, primarily for safety reasons, be stored such that the thinner edge of the film is directed upward. Due to the waviness, the wedge-shaped film needs some time after it is cut into sheets to become flat. For this, the sheets need, as a rule, a resting period of up to 48 hours.

European patent application EP 1 063 205 A1 presents an arrangement wherein two wedge-shaped strips of the same laminating film are rolled up in opposite directions on a winding roll such that a cylindrical cross-sectional profile of the roll results.

The object of the invention is to provide a method for transporting and storing a wedge-shaped film that has only slight crease and wave formation, even with relatively long transport and storage time at approx. room temperature.

The object of the present invention is accomplished according to the invention by a method in accordance with the independent claim 1. Preferred embodiments are apparent from the subclaims.

The object of the present invention is, consequently, accomplished by a method for rolling up a wedge-shaped film, in which at least one wedge-shaped film and at least one wedge-shaped intermediate layer are wound together onto a winding core, with the thicker edge of the wedge-shaped intermediate layer making at least flush contact with the thinner edge of the wedge-shaped film.

The object of the present invention is preferably accomplished in that the thickness of the thinner edge of the wedge-shaped film is from 0.7 mm to 0.9 mm and the thickness of the thicker edge is from 1.1 mm to 1.3 mm and the thickness of the thinner edge of the wedge-shaped intermediate layer is from 0.01 mm to 0.05 mm and the thickness of the thicker edge is from 0.4 mm to 0.55 mm. Very good results have been obtained with this preferred method. The wedge-shaped film demonstrated, even at room temperature and relatively long storage time, very slight crease formation after storage as well as very slight waviness after cutting. An important advantage of the lower thickness according to the invention of the wedge-shaped intermediate layer relative to the wedge-shaped film is the possibility, for example, compared to the procedure known from EP 1 063 205 A1, in which two identical wedge-shaped films are wound up in opposite directions, of rolling up a greater length of the wedge-shaped film with the same diameter of the wound roll. The roll is thinner and lighter with the same length of the wedge-shaped film.

In the context of the invention, a “wedge-shaped film” is a film that has a continuous nonlinear wedge angle profile or a continuous linear wedge angle profile.

A preferred solution of the object according to the invention is a method for rolling up a wedge-shaped film, wherein the wedge-shaped film and the wedge-shaped intermediate layer have a width of 0.9 m to 1.1 m. With these dimensions, very good results have been obtained in the reduction of crease formation after storage as well as waviness after cutting.

A preferred solution of the object according to the invention is a method for rolling up a wedge-shaped film, wherein the wedge-shaped film and the wedge-shaped intermediate layer have a length of 120 m to 160 m. With these dimensions, very good results have been obtained in the reduction of crease formation after storage as well as waviness after cutting.

A preferred solution of the object according to the invention is a method for rolling up a wedge-shaped film, wherein the wedge-shaped film and the wedge-shaped intermediate layer contain or are made of at least polybutylene terephthalate (PBT), polycarbonate (PC), polyethylene terephthalate (PET), polyethylene naphthalate (PEN), polyvinyl chloride (PVC), polyvinyl fluoride (PVF), polyvinyl butyral (PVB), ethylene vinyl acetate (EVA), polyacrylate (PA), polymethylmethacrylate (PMMA), polyurethane (PUR), polyethylene, and/or mixtures, copolymers, block copolymers or mixtures thereof. With these films, very good results have been obtained in the reduction of crease formation after storage as well as waviness after cutting.

In an advantageous embodiment of the invention, the wedge-shaped film and the wedge-shaped intermediate layer are made of materials different from one another. In particular, the material of the intermediate layer can be selected advantageously such that adhesion of the films is prevented. Thus, the invention differs substantially from the procedure known, for example, from EP 1 063 205 A1, in which two identical wedge-shaped films are wound up in opposite directions. Advantageously, relatively little or even no cooling of the wound roll is necessary such that costs during storage and transport can be saved. In particular, the wedge-shaped intermediate layer can be implemented as a disposable part (i.e., not for use for a composite pane). This primarily has advantages from a process technology standpoint since, for example, with two identical wedge-shaped films that are rolled up in opposite directions and intended for use for a composite pane, first, both films must be unrolled, with, during the further processing of one film, the other film usually having to be rolled back up, which is associated with increased production time, higher costs, and increased scrap. This can be avoided according to the invention.

A preferred solution of the object according to the invention is a method for rolling up a wedge-shaped film, wherein the wedge-shaped film is a thermoplastic polyvinyl butyral (PVB) film. With a thermoplastic polyvinyl butyral (PVB) film as a wedge-shaped film, excellent results have been obtained in the reduction of crease formation after storage as well as waviness after cutting.

A preferred solution of the object according to the invention is a method for rolling up a wedge-shaped film, wherein the wedge-shaped intermediate layer is a thermoplastic polyethylene (PE) film. With a thermoplastic polyethylene (PE) film as a wedge-shaped intermediate layer, excellent results have been obtained in the reduction of crease formation after storage as well as waviness after cutting.

In an advantageous embodiment of the invention, the wedge-shaped film is made of PVB and the wedge-shaped intermediate layer is made of PE. Thus, adhesion of the films can be prevented in a particularly advantageous manner. In addition, storage of the wound roll at room temperature is possible; cooling can, in a particularly advantageous manner, be entirely dispensed with.

The object of the invention is further accomplished by a wedge-shaped film rolled up according to the invention.

The object of the present invention is further accomplished by the use of a wedge-shaped film rolled up according to the invention for composite glass panes in vehicles, in particular as a windshield for displaying a head-up display or in buildings or as a data display.

The invention is explained in detail in the following with reference to figures and examples. The figures are purely schematic representations and not true to scale. They in no way restrict the invention.

They depict:

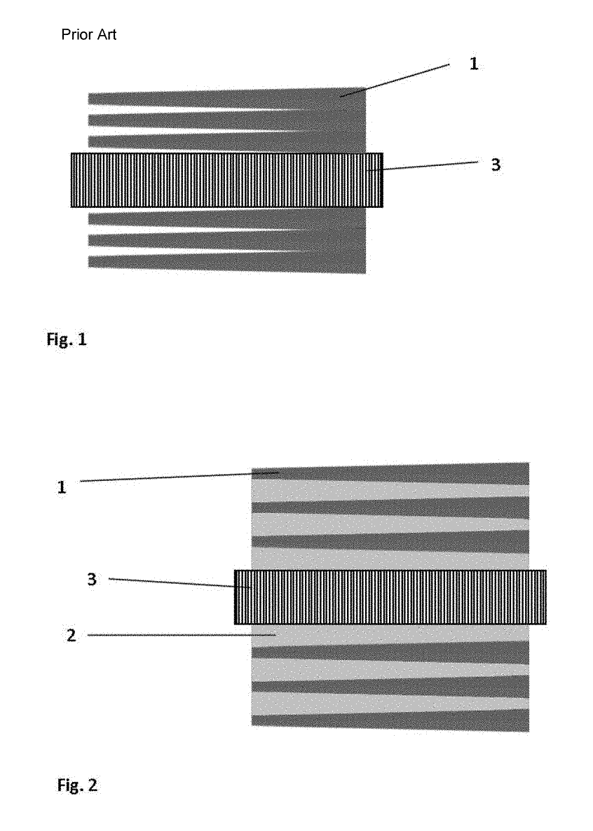

FIG. 1 a cross-section through a wedge-shaped film rolled up according to the prior art,

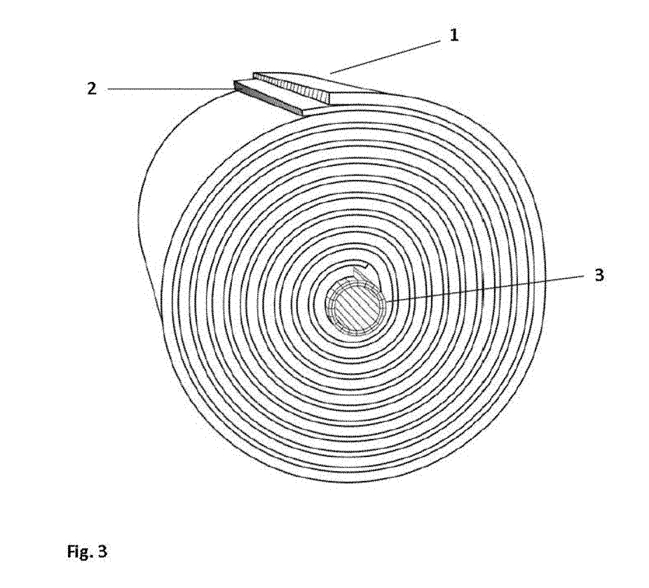

FIG. 2 a cross-section through a wedge-shaped film rolled up according to the invention,

FIG. 3 a side view of a wedge-shaped film rolled up according to the invention.

FIG. 1 depicts a cross-section through a wedge-shaped film 1 rolled up according to the prior art. It is discernible that, on the side of the thinner edge of the wedge-shaped film 1, there is a distance between the layers and wave formation occurs due to relaxation or shrinkage effects of the PVB film.

FIG. 2 depicts a cross-section through a wedge-shaped film 1 rolled up according to the invention. A wedge-shaped film 1 and a wedge-shaped intermediate layer 2 are wound together on a winding core 3. The thicker edge of the wedge-shaped intermediate layer 2 is positioned flush with the thinner edge of the wedge-shaped film 1. It is discernible that, on the side of the thinner edge of the wedge-shaped film, the distance is compensated by the thicker edge of the wedge-shaped intermediate layer and wave formation is avoided.

### EXAMPLES

### Comparative Example 1

A wedge-shaped PVB film was wound onto a core. The core had a diameter of 10 cm. The length of the wedge-shaped PVB film was 150 m. The width of the wedge-shaped PVB film was 1.0 m. The wedge-shaped PVB film had a thickness of 0.76 on the thin edge and, depending on the wedge angle, a thickness of 1.2 mm on the thicker edge. The rolled-up film had, on the side of the thicker edge, a roll diameter of 50.6 cm and on the side of the thinner edge, a roll diameter of 41.5 cm. The weight of the roll was 156 kg, disregarding the weight of the core on which the PVB film was wound.

The wedge-shaped PVB film was wound tightly on the side of the thicker edge and wound loosely on the side of the thinner edge. This resulted in creases on the side of the thinner edge. The creases increased with the length of storage of the wedge-shaped PVB film on the roll.

After the cutting of the wedge-shaped PVB film into sheets, they remained wavy. The sheets had creases on the side toward the engine edge.

The transport and storage temperature was kept between 2° C. and 10° C., in order to avoid adhesion of the PVB film and to prevent crease formation in the film made stiffer by cooling. The wedge-shaped PVB film could be stored only briefly on the roll, in order not to increase the formation of creases. The rolls were stored such that the thinner edge of the film was upward to effectively minimize crease formation.

Due to the waviness, the wedge-shaped PVB film requires some time after it had been cut into sheets to become flat. For this, the sheets usually require a rest period of 24 hours to 48 hours.

### EXAMPLE

The same wedge-shaped PVB film with the same dimensions and width as in the Comparative Example was used in the Example as well. In the Example, the wedge-shaped PVB film was wound onto a core together with a wedge-shaped PE film. The PE film was an intermediate layer. The thicker edge of the wedge-shaped PVB film and the thinner edge of the wedge-shaped PE film were positioned on the same side of the roll. The wedge-shaped PE film had a thickness of 0.03 mm on the thin edge and, depending on the wedge angle, a thickness of 0.47 mm on the thicker edge. The following Table 1 clearly presents the dimensions and weights of the PVB and PE. The weight of the roll was 185 kg, 156 kg PVB film and 29 kg PE intermediate layer, disregarding the weight of the core on which the PVB film was wound.

There was significantly less crease formation on the side of the thinner edge of the wedge-shaped PVB film. Even with relatively long storage of the wedge-shaped PVB film on the roll, no crease formation was observed on the thinner edge.

The transport and storage temperature was maintained, depending on the outside temperature, at up to 21° C. for a relatively long time without an increase in crease formation. The rolls were not stored separately and also without any special orientation.

Since the wedge-shaped PVB film had no creases, only a relaxation phase to get rid of production-related shrinkage was necessary after cutting the wedge-shaped PVB film into sheets. The resting time was 8 hours.

The properties of the PVB film and the PE film can be found in the following Table 1. The following Table 2 presents the differences and advantages of the method according to the invention.

TABLE 1

| | |
|---|---|
| | PE Film |
| PVB Film | (intermediate layer) |

| | | | | |
|---|---|---|---|---|
| Thickness (thinner edge) | 0.76 | mm | 0.03 | mm |
| Thickness (thicker edge) | 1.2 | mm | 0.47 | mm |
| Width of the film | 1 | m | 1 | m |
| Length of the film | 150 | m | 150 | m |
| Thickness of the film | 1060 | kg/m³ | 770 | kg/m³ |
| Weight of the film | 156 | kg | 29 | kg |

TABLE 2

| | Comparative | |
|---|---|---|
| | Example | Example |
| Transport and storage | 2° C. and 10° C. | up to 21° C. |
| temperature | | |
| Creasing after storage | Yes | No |
| Waviness after cutting | Yes | No |
| Resting time | 24 h to 48 h | 8 h |
| Storage time | Short | Significantly longer |

These advantageous results were surprising and unexpected for the person skilled in the art.

### LIST OF REFERENCE CHARACTERS

1 wedge-shaped film
2 wedge-shaped intermediate layer
3 winding core

1.-12. (canceled)

13. A method for rolling up a wedge-shaped film, comprising:
wounding together onto a winding core a wedge-shaped film and a wedge-shaped intermediate layer,
wherein the thicker edge of the wedge-shaped intermediate layer is positioned at wherein least flush on the thinner edge of the wedge-shaped film,
wherein the thickness of the thinner edge of the wedge-shaped film is from 0.7 mm to 0.9 mm and the thickness of the thicker edge is from 1.1 mm to 1.3 mm, and
wherein the thickness of the thinner edge of the wedge-shaped intermediate layer is from 0.01 mm to 0.05 mm and the thickness of the thicker edge is from 0.4 mm to 0.55 mm.

14. The method for rolling up a wedge-shaped film according to claim 13, wherein the wedge-shaped film and the wedge-shaped intermediate layer have a width of 0.9 m to 1.1 m.

15. The method for rolling up a wedge-shaped film according to claim 13, wherein the wedge-shaped film and the wedge-shaped intermediate layer have a length of 120 m to 160 m.

16. The method for rolling up a wedge-shaped film according to claim 13, wherein the wedge-shaped film and the wedge-shaped intermediate layer include polybutylene terephthalate (PBT), polycarbonate (PC), polyethylene terephthalate (PET), polyethylene naphthalate (PEN), polyvinyl chloride (PVC), polyvinyl fluoride (PVF), polyvinyl butyral (PVB), ethylene vinyl acetate (EVA), polyacrylate (PA), polymethylmethacrylate (PMMA), polyurethane (PUR), polyethylene, and/or copolymers, block copolymers, or mixtures thereof.

17. The method for rolling up a wedge-shaped film according to claim 13, wherein the wedge-shaped film is a thermoplastic polyvinyl butyral (PVB) film.

18. The method for rolling up a wedge-shaped film according to claim 13, wherein the wedge-shaped intermediate layer is a thermoplastic polyethylene (PE) film.

19. The method for rolling up a wedge-shaped film according to claim 13, wherein the wedge-shaped intermediate layer is a thermoplastic polyethylene (PE) film and the wedge-shaped film is a thermoplastic polyvinyl butyral (PVB) film.

20. The method for rolling up a wedge-shaped film according to claim 13, wherein the wedge-shaped film and the wedge-shaped intermediate layer are made of materials different from one another.

21. The method for rolling up a wedge-shaped film according to claim 20, wherein the wedge-shaped intermediate layer is made of a material such that adhesion of the wedge-shaped film and the wedge-shaped intermediate layer is prevented at room temperature.

22. The method for rolling up a wedge-shaped film according to claim 13, wherein the wedge-shaped intermediate layer is implemented as a disposable part.

23. A rolled up wedge-shaped film, comprising:
a wedge-shaped film; and
a wedge-shaped intermediate layer, wound together with the wedge-shaped film onto a winding core,
wherein the thicker edge of the wedge-shaped intermediate layer is positioned at wherein least flush on the thinner edge of the wedge-shaped film,
wherein the thickness of the thinner edge of the wedge-shaped film is from 0.7 mm to 0.9 mm and the thickness of the thicker edge is from 1.1 mm to 1.3 mm, and
wherein the thickness of the thinner edge of the wedge-shaped intermediate layer is from 0.01 mm to 0.05 mm and the thickness of the thicker edge is from 0.4 mm to 0.55 mm.

24. A method of using a rolled up wedge-shaped film, comprising:
providing the rolled up wedge-shaped film according to claim 23; and
using the wedge-shaped film in composite glass panes.

25. The method of using a rolled up wedge-shaped film according to claim 24, comprising:
using the wedge-shaped film in composite glass panes of vehicles.

26. The method of using a rolled up wedge-shaped film according to claim 25, comprising:
using the wedge-shaped film as a windshield for displaying a head-up display.

27. The method of using a rolled up wedge-shaped film according to claim 24, comprising:
using the wedge-shaped film in composite glass panes of buildings.

28. The method of using a rolled up wedge-shaped film according to claim 24, comprising:
using the wedge-shaped film in composite glass panes as an information display.
